(19) United States
(12) Patent Application Publication
(10) Pub. No.: US 2010/0149130 A1
(43) Pub. Date: Jun. 17, 2010

(54) SENSITIVITY-VARIABLE TOUCH SENSOR ACCORDING TO USER INTERFACE MODE OF TERMINAL AND METHOD FOR PROVIDING THE SAME

(75) Inventors: Sun-Tae JUNG, Yongin-si (KR); Byung-Duck Cho, Seoul (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/638,442

(22) Filed: Dec. 15, 2009

(30) Foreign Application Priority Data
Dec. 15, 2008 (KR) 10-2008-0127171

(51) Int. Cl. G06F 3/045

(52) U.S. Cl. 345/174

(57) ABSTRACT

A method for improving the convenience in use of a touch sensor and a touch screen applied to a portable terminal and a terminal using the method are provided. The method includes determining a current user interface mode and function of the terminal; searching for an optimum sensitivity value corresponding to the determined user interlace mode and function; and setting the sensitivity value of the touch sensor to the optimum sensitivity value.

### PRIORITY

This application claims priority under 35 U.S.C. §119(a) to a Korean Patent Application filed in the Korean Intellectual Properly Office on Dec. 15, 2008 and assigned Serial No. 10-2008-0127171, the contents of which are incorporated herein by reference.

### BACKGROUND OF THE INVENTION

1. Field of the Invention

The present invention relates generally to a terminal that uses a touch screen provided with a touch sensor, and more particularly to a method of variably adjusting the sensitivity of a touch sensor according to a user interface mode and function of a terminal, and a terminal using the method.

2. Description of the Related Art

As the use of digital portable terminals becomes increasingly popular and high performance digital portable terminals are introduced as information processing devices, a variety of methods for processing user input information have been provided. These input methods enable a user to readily use functions of digital portable terminals, such as functions of a phone book; short message preparation, an electronic notepad, etc. One such method uses a touch screen.

A touch screen system, due to its convenient, user interlace, has been widely used for functions such as a phone book, scheduler, short message services, private information management, Internet access, electronic dictionary, etc. These functions may be performed, in devices such as a Portable Digital Assistant (PDA), a smart phone combined with a portable phone, an Internet, phone, and etc. In particular, since a touch screen can enable a user to directly perform a desired operation as the user looks at the screen, and can readily be manipulated by most users, a touch screen input method has been evaluated as an ideal input method in a Graphical User Interface (GPU) environment.

Recently, with the development of the electronic communications industry, a variety of portable terminals provided with touch screens have appeared. Portable terminals are following a trend of integrating] various combined functions into one appliance, in addition to voice communication functions.

Specifically, a Motion Picture experts' group audio layer-3 (MP3) player function may be provided in a portable terminal for listening to music, and a camera module may be mounted on a portable terminal to capture high-quality still images or moving images. A broadcast receiving function may be provided in a portable terminal in order to receive ground-wave or satellite broadcasts, and a Global Positioning System (GPS) function may be provided in a portable terminal for obtaining location-based services. In order to support such various functions, many different User Interfaces (UIs) may be displayed in a small space, and thus a wider screen may be required. Accordingly, many portable terminals utilize touch screens that enable wide-screen display.

However, with the recent trend of a miniaturization and weight-reduction of portable terminals, the size of the touch screen, may also be miniaturized and weight-reduced to that the same extent. Accordingly, in many portable terminals using a touch screen, no separate keyboard is provided, and a user interlace is provided through touch of the touch screen using a user's finger, or stylus pen, for example.

The input onto the touch screen is implemented through a touch sensor. Resistive type and capacitive type touch screens are mainly used in portable terminals.

FIG. 1 is an example of a conventional resistive type touch screen. Referring to FIG. 1, in a resistive type touch screen 100, spacers 105 are interposed, between thin films on which transparent electrodes 103 are formed as shown in FIG. 1, and an input is made when an upper layer 101 the touch screen is pressed by a finger or a stylus pen.

FIG. 2 is an example of a conventional capacitive type touch screen. Referring to FIG. 2, in a capacitive type touch screen 200, the touch screen 200 comprises an insulator 209 located on the surface display, two Indium Tin Oxide (ITO) layers 205, a substrate 207, and insulated layer 203, an input is received through sensing of a change of capacitance 201 occurring between a finger and a transparent electrode 205 as shown in FIG. 2.

Portable terminals provided with a touch screen may have diverse input modes in accordance with various menus and functions, and may further have a UI according to a respective input mode displayed on the touch screen. For example, when a phone call function is performed, numerals, an asterisk key *, a pound key #, and the like, may be displayed on the screen. In the case in which a text input function is performed, text sets of several countries, such as English, Hangeul, and the like, may appear on the screen to enable a user to perform menu display, document editing, message preparation, etc. in various languages. When performing a multimedia function such as playing music, displaying moving images, etc., control keys for adjusting multimedia functions, such as file search, playback, pause, rewind, last forward, and the like, are displayed. When performing a scroll function for searching for a desired item located in several lists, such as files or addresses, a UI required for scrolling is displayed. When performing a camera function, control keys necessary for photography, image editing, and storage after taking a picture, etc., are displayed.

If the sensitivity of a touch sensor mounted on the touch screen is set to be high, an input error of the touch sensor may occur. For example, an operation may be performed even before a user makes a corresponding input, on the touch screen, or an unwanted key may be input despite a user's intention to press another neighboring key on the touch screen. By contrast, if the sensitivity of the touch sensor is lowered to reduce the input error, the touch sensor may sense input signals only after the user presses the touch screen several times, which is inconvenient for the user.

If the input area of the terminal is relatively larger than the area of the input means, e.g. if the input area is relatively larger than the user's finger or the stylus pen, from the viewpoint of the UI of the terminal, errors are less likely to occur, even when the sensitivity of the touch sensor is low.

Also, if a plurality of keys are arranged on a screen and the input area, of the terminal, is relatively smaller than the area of the input means, e.g., if the input area is relatively smaller than the user's finger or the stylus pen, from the viewpoint of the UI of the terminal, the sensitivity of the touch sensor may be set to be high, to prevent the error occurrence.

Accordingly, there is a need for a scheme for setting an input sensitivity suitable for a touch sensor and operating the touch sensor without error occurrence, even when a user uses various input modes.

### SUMMARY OF THE INVENTION

Accordingly, the present invention provides an apparatus and method for reducing an input error using a sensitivity-variable touch sensor for a more convenient user interlace.

The present invention provides a method for varying the sensitivity of a touch sensor of a terminal. The method includes determining a current user interface mode, and function of the terminal; searching for an optimum sensitivity value corresponding to the determined user interlace mode and function; and setting the sensitivity value of the touch sensor to the optimum sensitivity value.

Also, the present invention provides an apparatus for varying the sensitivity of a touch sensor provided in a terminal. The apparatus includes a control unit for determining a current user interface mode and function of the terminal, and searching for an optimum sensitivity value corresponding to the determined user interface mode and the function; and a sensitivity adjustment unit for setting the sensitivity value of the touch sensor to the searched optimum sensitivity value, and setting the optimum sensitivity value in the touch sensor.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating a conventional resistive type touch screen;

FIG. 2 is a diagram illustrating a conventional capacitive type touch screen;

FIG. 3 is a diagram illustrating an outer part of a portable terminal provided with a sensitivity-variable touch sensor and a touch screen mounted thereon according to an embodiment of the present invention;

FIG. 4 is a diagram illustrating an inner construction of a portable terminal provided with a sensitivity-variable touch sensor and a touch screen mounted onto the sensitivity-variable touch sensor according to an embodiment of the present invention; and

FIG. 5 is a functional block diagram illustrating a method performed in a portable terminal according to an embodiment of the present invention, for automatically adjusting the sensitivity of a touch sensor in accordance with a UI of the portable terminal.

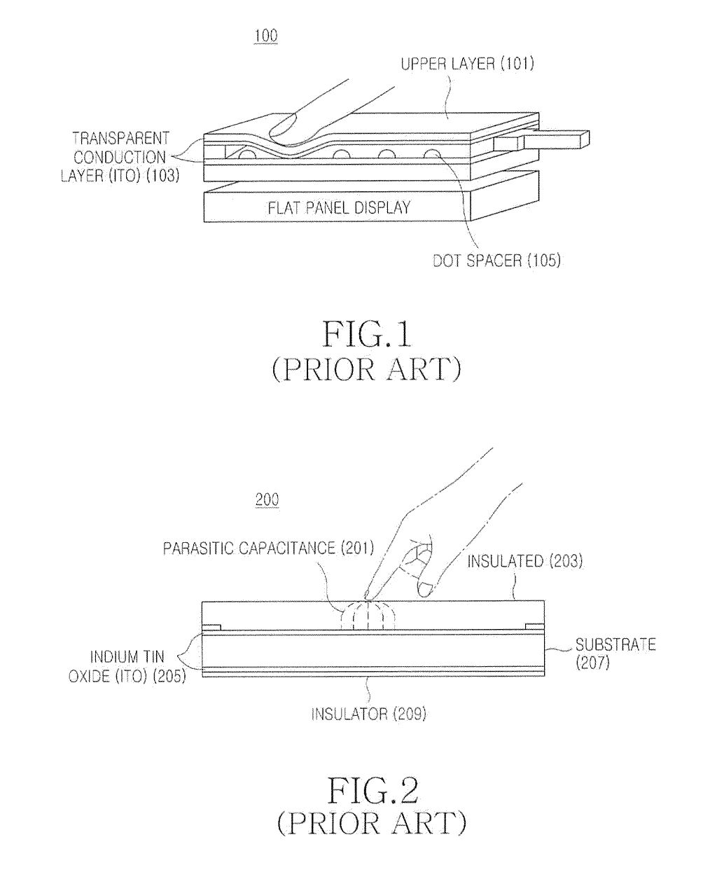

### DETAILED DESCRIPTION OF EMBODIMENTS OF THE INVENTION

Hereinafter, embodiments of the present invention will be described with reference to the accompanying drawings. In the following description, the same elements will be designated by the same reference numerals, even when they are illustrated in different drawings. Further, various specific definitions found in the following description, such as specific values of packet identifications, contents of displayed information, etc., are provided only to help the general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear.

The present invention provides a user interface apparatus and method using a sensitivity-variable touch sensor that reduces an input error by automatically adjusting the sensitivity in accordance with a user's input mode in a portable terminal using a touch screen.

Although in the following detailed description of the present invention, explanation will be made based on a mobile communication terminal, it would be apparent to one of skilled in the art that the apparatus and method provided according to the present invention can be applied to a portable terminal using a touch screen.

Hereinafter, preferred embodiments of the present, invention will be described in detail with reference to the accompanying drawings.

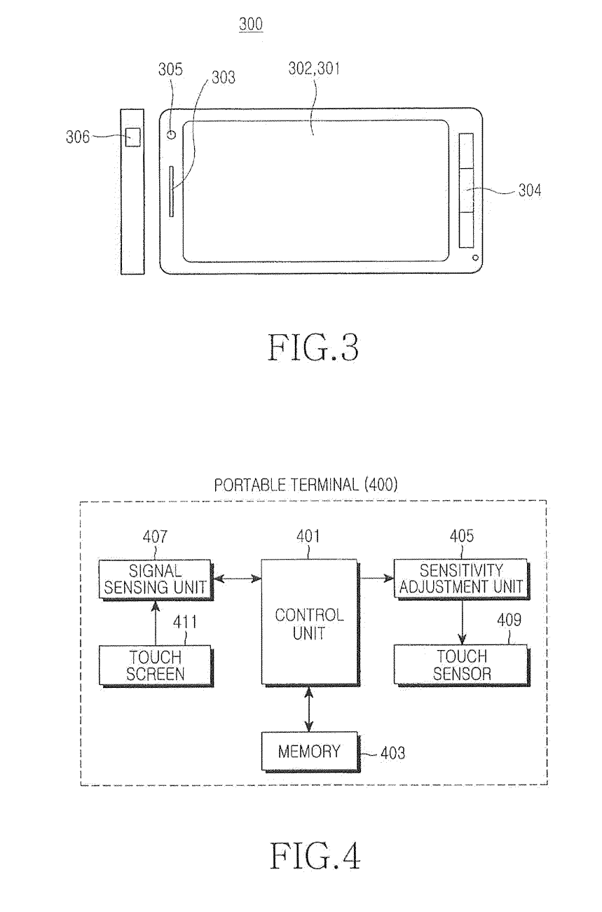

FIG. 3 is a diagram illustrating an outer part of a portable terminal provided with a sensitivity-variable touch sensor and a touch screen mounted thereon according to an embodiment of the present invention.

Referring to FIG. 3, the outer part, of the portable terminal 300 includes a display unit 301, a touch screen 302, a speaker 303, control keys 304, a camera 305, and a power switch 306. The power switch 306 turns a power supply to the portable terminal 300 on/off, and a User Interface (UI) of the terminal is displayed on the touch screen 302 (i.e., the display unit 301) in accordance with a user's input.

For example, in the case of performing a phone call function, numerals, an asterisk key *, a pound key #, etc. are displayed on the touch screen 302, and in the case of performing a text input function, text sets of several countries, such as English, Hangeul, and the like, are displayed on the touch screen 302. In the ease of performing a multimedia function such as playing music, displaying moving images, and etc., control keys for adjusting multimedia functions, such as file search, playback, pause, rewind, fast forward, and the like, are displayed on the touch screen 302. When performing a scroll function for searching for a desired item in a list, such, as a file or an address, a UI required for scrolling is displayed on the touch screen 302 When performing a camera function, control keys required for capturing an image, image editing and storage after image-capture are displayed on the touch screen 302.

The control keys 304, which may be located on various sides of the mobile terminal 300, are classified as separate keys for performing functions frequently used. The camera 305 is used to photograph a still image or a moving image, and the speaker 303 is used to output an opposite party's voice, music sounds, etc.

If an area to be touched is equal to or larger than an area of a touch input means, e.g. a finger or a stylus pen, and if the present mode is a UI mode that requires the performance of a sensitive operation, the portable terminal according to the present invention increases the sensitivity of the touch sensor to make a corresponding operation perform smoothly, even in response to a small motion or change of a finger. Also, if the area, to be touched is equal to or relatively smaller than the area of the touch input means, e.g., a finger, and if the present mode is a UI mode that requires the performance of an insensitive operation, the portable terminal reduces the sensitivity of the touch sensor to make a corresponding operation performed for a sufficient time with respect to the movement of the finger.

For example, if a user of a portable terminal that can perform mobile communication intends to listen to music, a user may be required to search for and select a desired song in a music list and thus the user may desire prompt selection. In this case, the portable terminal heightens the sensitivity of the touch sensor to make increase the speed of a scrolling action corresponding to selecting a song. When a user sends a message, a keyboard for displaying many characters may be required. However, the displayed size of each character may be smaller than a finger of the user, in a portable terminal having a small-sized display screen. Therefore, many input errors may occur. Accordingly, by lowering the sensitivity of the touch sensor 409, the input signal can be sensed, only when the center of the finger is accurately positioned on the character desired by the user, and thus the text input error can be reduced.

FIG. 4 is a view illustrating an inner construction of a portable terminal 300 provided with a sensitivity-variable touch sensor and a touch screen mounted thereon according, to the present invention.

Referring to FIG. 4, a portable terminal 400 includes a control unit 401, a memory 403, a sensitivity adjustment unit 405, a signal sensing unit 407, a touch sensor 409, and a touch screen 411.

In the following description of the present invention, parts of the operation of the above-described constituent elements, which do not relate to the contents of the invention, will be omitted.

The signal sensing unit 407 senses a touch signal input by a user on the touch screen 411. The control unit 401, which may include a modem chip, controls overall operations of the portable terminal 400. The control unit 401 evaluates the current terminal UI selected by the user by comparing the touch area of the touch signal sensed by the signal sensing unit 407 with the size of an input means, such as a finger or a stylus pen. The control unit 401 also evaluates the current function of the portable terminal 300 by searching for a currently set UI mode in the memory 403.

Thereafter, the control unit 401 searches for the sensitivity value corresponding to the current terminal UI in the memory 403. The control unit 401 controls the sensitivity adjustment unit 405 to adjust the sensitivity of the touch sensor 409 mounted on the portable terminal according to the sensitivity value searched from the memory 403. According to certain embodiments of the present invention, the UI according to the function that the user intends to use may have already been previously set in the memory 403.

Therefore, the control unit 401 is able to determine, the user mode and the function currently performed, and obtain a manipulation sensitivity value previously set, in order to set the manipulation sensitivity value of the touch sensor.

According to the present example, the UI mode of the terminal and the sensitivity value of the touch sensor according to the function of the terminal have already been set in the memory 403. The set sensitivity value is an optimized, value acquired through various experiments. The optimized sensitivity value may be pre-set and displayed in a lookup table, and/or the optimized sensitivity value may be set according to a user's preferences.

In the case of adjusting the sensitivity value of the touch sensor 409, the threshold value of the touch signal may be adjusted. That is, if the threshold value of the touch signal is set to be high, the touch sensor 409 becomes insensitive, and thus the input, of the touch signal can be sensed only when a high touch signal, is produced (e.g., in the case of using a capacitive type touch sensor, when a large amount of capacitance is changed). By contrast, if the threshold value of the touch signal is set to be low, the input of the touch signal can be sensed even when a low touch signal is produced (e.g., in the ease of using a capacitive type touch sensor, when a small amount of capacitance is changed). Accordingly, by automatically adjusting the manipulation sensitivity of the touch sensor in accordance with the user input mode in the portable terminal using the touch screen, the user's input error can be reduced.

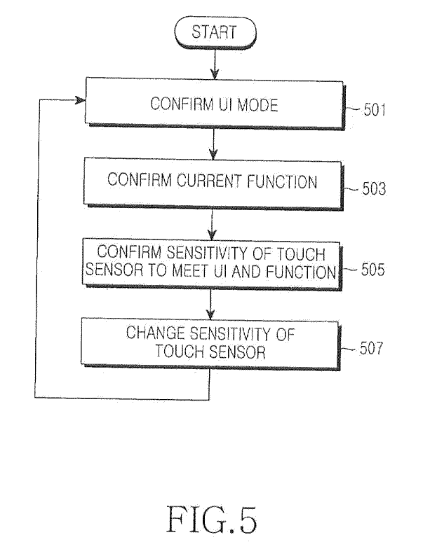

FIG. 5 is a functional block diagram illustrating a method performed in the portable terminal 400 for automatically adjusting the sensitivity of a touch sensor in accordance with UI of the portable, terminal.

Referring to FIG. 5, the control unit 401 determines the current UI mode of the portable terminal 400 through the touch signal input to the signal sensing unit 407 in step 501. As described above, the UI has already been set in accordance with a function to be used. Then, the control unit determines the currently set function in the memory 403, in step 503.

After sensing the current UI mode and function, the control unit 401 searches for a sensitivity value, which has been optimized and preset for each user interface mode sensed through diverse experiments, in the memory 403 in step 505. The optimized sensitivity value may be pre-displayed in a lookup table, or may be set to meet the user's taste and condition. A lookup table set and supplied by a portable terminal manufacturer and a lookup table set by the user to meet the user's taste may be discriminated from each other.

As a method capable of setting the sensitivity value to meet the user's taste, there may be a method of providing “high”, “intermediate,” and “low” sensitivity mode selection to a user. In this case, the user may pre-select and set a preferred sensitivity value for each UI that the user intends to operate, and when the user uses the value thereafter, a corresponding preferred sensitivity value may be automatically selected, so that the user can search for and use the sensitivity value suitable for the user.

The control unit 401 controls the sensitivity adjustment unit 405 to adjust the threshold value of the touch signal to the searched optimized threshold value according to the type of the current UI, and then adjusts the sensitivity for sensing the touch signal of the touch sensor 409 in step 507.

By automatically adjusting the manipulation sensitivity of the touch sensor in accordance with the user input mode through the above-described method, the user's input error can be reduced.

In the detailed description of the present invention as described above, the sensitivity of a touch screen is automatically adjusted in accordance with the user interface and function in the mobile communication terminal provided with the touch sensor. However, the present invention can be applied to all terminals 3 having a similar technical background and a touch sensor without greatly departing from the scope of the invention, and this can be understood by one of skilled in the art to which the invention pertains.

As described above, according to the present invention, by automatically changing the sensitivity of the touch sensor used in the portable terminal to meet the UI mode used by the user, errors in use, such as unwanted key input and so on, can be reduced to improve the convenience in use of the touch sensor and the touch screen applied to the portable terminal.

While the invention has been shown and described with reference to certain embodiments thereof it will be understood by those skilled in the art that various changes in form and details may be made therein without departing from the spirit and scope of the invention as defined by the appended claims.

What is claimed is:

1. A method for varying a sensitivity of a touch sensor of a terminal comprising the steps of:
determining a current user interface mode and function of the terminal;
searching for an optimum sensitivity value corresponding to the determined user interlace mode and function; and
setting the sensitivity value of the touch sensor to the optimum sensitivity value.

2. The method as claimed in claim 1, determining the current, user interlace mode includes determining the current user interface mode of the terminal by comparing a touch area of a touch signal provided from a signal sensing unit, with a size of an input means.

3. The method as claimed in claim 2, wherein determining the function includes determining the current function of the terminal by searching for a currently set user interlace mode in a memory.

4. The method as claimed in claim 1, further comprising presetting an optimum sensitivity value corresponding to the current, user interface mode and function of the terminal in a memory.

5. The method as claimed in claim 1, wherein the sensitivity value includes a threshold value of a touch signal.

6. An apparatus for varying the sensitivity of a touch sensor provided in a terminal, comprising:
a control unit for determining a current user interface mode and function of the terminal, and searching for an optimum sensitivity value corresponding to the determined user interface mode and the function; and
a sensitivity adjustment unit for setting the sensitivity value of the touch sensor to the searched optimum sensitivity value, and setting the optimum sensitivity value in the touch sensor.

7. The apparatus as claimed in claim 6, further comprising a memory unit for storing at least one optimum sensitivity value is preset according a respective user interface mode and function of the terminal.

8. The apparatus as claimed in claim 6, wherein the sensitivity value includes a threshold value of a touch signal.
